(19) United States
(12) Patent Application Publication
(10) Pub. No.: US 2020/0391313 A1
(43) Pub. Date: Dec. 17, 2020

(54) CHAMFERING TOOL, CHAMFERING SYSTEM, GEAR-CUTTING MACHINE AND METHOD FOR CHAMFERING TOOTHINGS

(71) Applicant: GLEASON-PFAUTER MASCHINENFABRIK GMBH, Ludwigsburg (DE)

(72) Inventor: Ralf Schmezer, Ludwigsburg (DE)

(21) Appl. No.: 16/971,834

(22) PCT Filed: Sep. 6, 2018
(86) PCT No.: PCT/EP2018/074054

§ 371 Date: Aug. 21, 2020

(30) Foreign Application Priority Data
Feb. 26, 2018 (DE) 10 2018 001 477.1

(51) Int. Cl. B23F 19/10; B23F 21/00; B23F 21/16

(52) U.S. Cl. CPC B23F 19/107; B23F 19/104; B23F 5/16; B23F 21/16; B23F 21/005

(57) ABSTRACT

The invention relates to a chamfering tool (4) for chamfering workpiece toothings (22), comprising a helical toothing having, for each flight, a plurality of teeth (5) with a geometrically defined cutting edge and having a tooth profile (8, 9; 8′, 9′) which is designed for single-flank machining in rolling machining engagement with the workpiece toothing and asymmetrical as viewed in the axial section of the tool. The invention further relates to a chamfering system (100), to a gear-cutting machine, and to a method for producing a chamfer on the tooth edges of a tooth flank side of a workpiece toothing.

The invention relates to a chamfering tool for chamfering workpiece toothings and a method for chamfering toothings carried out by said tool.

As is known, burrs are produced at the end tooth edges when toothings are machined, which burrs must be removed for various reasons. Moreover, for many applications it is not sufficient to simply remove the burr. This is because if the tooth edge is otherwise unmachined, there is a risk that the latter will become glass-hard during the subsequent hardening of the toothing due to over-carburization and then break out under load. For these reasons, the tooth edge should be chamfered, for which numerous techniques have been developed.

A technique that is often used nowadays consists in plastic reshaping of the tooth edge into a chamfer, in which technique the material of the workpiece is displaced in the region of the tooth edge by a chamfering wheel rolling into engagement with the tooth, as disclosed for example in EP 1 279 127 A1. The displaced material is then suitably removed, as described for example in DE 10 2009 018 405 A1.

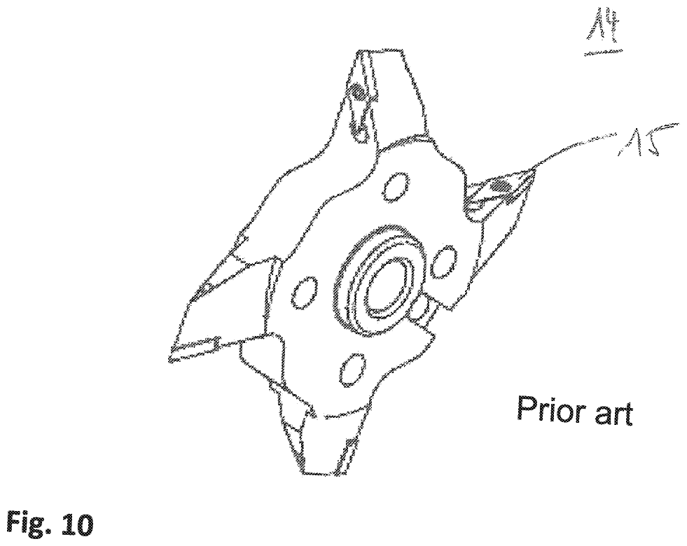

There are also cutting methods in which the chamfer is produced on the tooth edge by cutting. For this purpose, fly cutters (FIG. 10) having a cutting edge shape that is independent of the toothing can be used, the position of which fly cutters, including axial spacing and pivot angle, is suitably guided during chamfering in order to allow the cutting engagement to follow the profile shape of the workpiece toothing in a rolling motion. A form of a cutting chamfering tool that is similar in appearance to a fly cutter is the “chamfer cutter” disclosed in EP 1 495 824 B1, which is also disk-shaped, but has teeth of which the cutting edge shape depends on the toothing. In such a profile cutter, the profile shape of the cutter teeth is matched to the tooth gap profile of the workpiece toothing. During chamfering, a cutter tooth cuts the entire chamfer contour of a tooth gap. This produces a rolling movement between the profile cutter and the toothing such that the cutter tooth directly following a cutter tooth cuts the tooth gap directly following the initially cut tooth gap, etc. Such chamfering tools are also discussed in DE 10 2013 015 240 A1.

Moreover, variants of chamfering tools have also been proposed which remove material using a geometrically undefined cutting edge, as disclosed in DE 10 2016 004 112 A1, i.e. which chamfer by grinding. This variant has the advantage that reprofiling the chamfering tool achieves higher flexibility, such that if, for example, parameters of the desired chamfer are changed, it is not necessary to design an entire new chamfering tool. Moreover, chamfering by grinding results in a high surface quality of the chamfer surface.

All these chamfering tools have their specific strengths and weaknesses. The object of the invention is to provide a chamfering tool which leads to a satisfactory compromise between not excessive machining time and satisfactory machining accuracy and flexibility.

In terms of tool technology, this object is achieved by a chamfering tool for chamfering workpiece toothings, comprising a helical toothing having, for each flight, a plurality of teeth with a geometrically defined cutting edge and having a tooth profile which is designed for single-flank machining in rolling machining engagement with the workpiece toothing and is asymmetrical as viewed in the axial section of the tool.

The chamfering tool according to the invention is therefore in rolling machining engagement with the toothing to be chamfered during chamfering; however, only one cutting side of the profile is chamfered, while the counter flank of the chamfered tooth gap is not machined. For this purpose, the tooth profile is asymmetrical. Moreover, a plurality of teeth for each flight are provided, preferably at least 2, more preferably at least 4, particularly preferably at least 6 teeth, such that one tooth does not produce the entire chamfer between the tooth tip and the tooth root of the workpiece toothing; rather, the chamfer on one flank of the workpiece toothing is produced by a plurality of successive meshes of different teeth and is thus composed of a plurality of enveloping portions of the chamfering helix. The cutting machining produces better machining times than, for example, in grinding chamfering. The tool design with a plurality of teeth for each flight distributes the tool wear over a plurality of teeth, which leads to more favorable load conditions. In addition, due to the rolling machining engagement it is possible to work with a constant axial spacing, which makes the machining process easier. Single-flank machining also allows greater flexibility in the chamfer design of the left and right flanks of the chamfered toothing. This means that a differently designed chamfering tool can be used for the other flank. The design of the asymmetrical chamfering worm according to the invention thus also differs fundamentally from hobs used for hobbing having a rack-like tool profile.

In the asymmetrical tooth profile of the chamfering tool, the cutting side has a flatter tooth flank in comparison with the non-cutting side. In a preferred design of the chamfering tool, the ratio of the axial length of the non-machining tooth flank side of the tooth profile to the axial length of the machining side is smaller than 1, preferably smaller than 0.9, in particular smaller than 0.8, and/or is greater than 0.05, preferably greater than 0.1, in particular greater than 0.2. This allows favorable profile designs of the cutting side while maintaining a stable tooth shape.

In particular for a chamfering tool chamfering the blunt side of a tool, this ratio can also be smaller than 0.7, even smaller than 0.6, in particular smaller than 0.5.

In particular for chamfering involute toothings and the root rounding thereof, the tooth profile on the machining tooth flank side preferably consists of a concave part and a convex part. The concave part consists, as viewed from the root to the inflection point, of continuously decreasing curves. This design allows a transition from the chamfer flank into the gear flank in a plane that is parallel to the gear end face.

Moreover, it is preferably provided that the change in the angle of pressure of the tooth profile on the machining tooth flank side between the tooth root after the tooth root rounding and transition decreases into the convex region (inflection point), with a relative change factor of greater than 0.1, preferably greater than 1, in particular greater than 2 and/or smaller than 10. For example, the angle of pressure can therefore be 3 times as small at the inflection point than after the tooth root rounding.

In a particularly preferred embodiment, the axial length of the chamfering tool extends beyond the contact length, comprising at least two tool teeth, of the machining operation. The contact length refers to the length projected onto the tool axis over which the tool is loaded in machining operation (without tangential offsets). Here, at least two teeth are involved; depending on the centricity of the machining position and the number of teeth, there may well be three or more teeth. Due to the greater axial length of the chamfering tool, if the relative position of the tool and workpiece is repositioned, other tool teeth can come into machining engagement with the workpiece at least in part. This repositioning could be directly a displacement of the tool along its axis, or could have a similar effect to such a displacement, for example by overlaying linear axial movements. Preferably, all the teeth of the tool which are capable of cutting have the same profile and the same tooth height for this purpose. Preferably, the tool teeth are designed identically with regard to their cutting action; in particular, pre-cutting teeth, specially designed initial teeth or inactive teeth are dispensed with. This produces an efficient chamfering tool.

In this context, the axial length of the chamfering tool extends at least 50%, in particular at least 100%, of the contact length beyond the contact length. The advantage of this design is an achievable longer tool service life, since, for example, when a certain level of wear is reached in one tool region, the tool does not need to be replaced by a replacement tool, but can be chamfered further with another tool region of the chamfering tool.

For the design of the tooth profile to a desired chamfer (with a chamfer width (during chamfering, a tooth edge machining, the tooth thickness of the workpiece at the end face is tapered by less than 20%, or by less than 15% or even less than 10%, as the case may be, unlike the so-called sharpening or beveling of a toothing, in which the workpiece teeth on the end face lose more than 50% of their tooth thickness, i.e. the entire tooth is machined) and a chamfer angle), a plurality of variants are conceivable. It is expedient to first set parameters of the chamfering tool, such as the external diameter of the helical toothing (chamfering worm or hob) and the number of flights. It is possible here to use hobbing as a reference, i.e. suitable external diameters and numbers of flights can be in a range in which a person skilled in the art would typically select a hob for producing the toothing to be chamfered. When designing the tool, it is also expedient to consider the axis constellation in which the machining operation is to take place, i.e. the pivot angle of the tool axis at which work is to be carried out, as viewed along the workpiece axis, which consists of the spacing between the tool axis of rotation at the level of the contact and the position of the end face of the tool toothing (hobbing offset angle). If a majority of the occurring parameters are set in this manner, the profile shape of the machining side of the tool profile can be optimized experimentally proceeding from a starting profile by observing the chamfering results. Alternatively, a profile shape can also be designed by a computer by simulation, by the “half profile” (only one flank at the gap) to be machined of the workpiece toothing being considered and the enveloping screw of the tool being considered in the end plane of the workpiece which is spaced apart from the end face of the workpiece toothing by the desired chamfer width, as at this point there should be agreement with the profile of the workpiece toothing. For the non-cutting side, it is only necessary to ensure that its penetration curve does cause a collision with the other workpiece flank (other half profile). If it is found that a larger chamfer angle than desired is produced/would be produced, the pivot angle is selected to be slightly smaller and vice versa. With regard to the lead angle of the flight(s), a value of less than 30° is preferably provided.

As already discussed above, a chamfering tool can be formed differently for each of the left and right flanks of the workpiece toothing. The invention therefore also comprises a chamfering system consisting of two or more chamfering tools according to one of the above-mentioned aspects, in which system a first chamfering tool is designed for single-flank chamfering of the tooth flanks on the left flanks of the tool toothing and a second, in particular differently formed chamfering tool is designed for single-flank chamfering of the tooth edges on the right flanks of the workpiece toothing. Preferably, the at least two chamfering tools are arranged on a common tool spindle of a tool head and are driven by the same spindle drive. However, it is also conceivable in principle for each tool to have its own tool spindle with its own drive. In this case, the chamfering system in particular has four chamfering tools, one tool for each of the left and right flanks on one end face and on the other end face of the workpiece toothing. In terms of production, the chamfering tool is preferably made of solid material by material removal, i.e. in one piece. This is more preferred even if a plurality of tools having the same carrier are provided; in this case, the combination tool formed of a plurality of hobs is preferably made entirely of solid material.

In a particularly preferred embodiment, a tool head carrying one or more chamfering tools and designed for driving same in rotation can be moved with respect to the workpiece axis of rotation in at least one, preferably at least two, in particular three, linearly independent spatial axes and can be pivoted for an angle of inclination of the tool axis with respect to the workpiece axis, a pivot device that causes this pivotability being directly carried by a slide, in particular a radial slide setting the axial spacing between the axes, and this slide being carried by a slide arrangement causing the remaining spatial axis movements.

This design therefore differs from tool head position arrangements which are typical for helical tools and in which a linear movement axis is carried along the tool axis of rotation by the pivot device. This design reduces the weight of the pivot when changing the pivot angle, which is preferably carried out between machining the left flanks of the workpiece toothing and machining the right flanks of the workpiece toothing. If the radial slide carries the pivot device, the most frequently used slide can also be loaded with the lowest weight in relative terms. The design in which the pivot device is directly carried by the radial slide is also considered advantageous irrespective of the type of design of the chamfering tool and is correspondingly disclosed to be independent and capable of being protected independently.

The invention therefore also relates to a chamfering system in which a tool head carrying one or more chamfering tools and designed for driving same in rotation can be moved with respect to the workpiece axis of rotation in at least one, preferably at least two, in particular three, linearly independent spatial axes and can be pivoted for an angle of inclination of the tool axis with respect to the workpiece axis, a pivot device that causes this pivotability being directly carried by a radial slide determining the axial spacing between the axes, and this radial slide being carried by a slide arrangement causing the remaining spatial axis movements.

In a particularly preferred embodiment, the pivot device allows pivoting by +/−120° or more, in particular by +/−160° or more. In this way, for example, in the case of two chamfering tools according to the invention on a common tool spindle, the tooth edges on the other end face of the workpiece toothing can also be chamfered after pivoting said spindle. In this case, a machining sequence is freely adjustable to a large extent; preferred variants are first the chamfering of the left and right flanks on an end face (for example, the non-moving end face of the production of the workpiece toothing, if this is in particular already taking place simultaneously at a main machining position offset with respect to the chamfering position), and subsequently the chamfering on the other end face. However, in particular in the case of a separate chamfering station, a chamfering tool can first chamfer the flanks assigned thereto on both end faces, and subsequently the other chamfering tool can be used.

In a further embodiment of the chamfering system, a further one or more fly cutters are provided as an additional chamfering tool(s). Fly cutters are disk-shaped tools which have at least one, preferably a plurality, of cutting edges at the same spacing on the circumference, are in a rolling movement with the toothing for cutting a chamfer flank, are guided on a spatial path curve along the profile shape of the toothing and thereby assume a changing position relative to the toothing in which all three linear axes X, Y and Z and the pivot axis A and workpiece axis C are continuously adjusted. One or more fly cutters are used, which in particular are also arranged in the same tool head, i.e. are clamped on a common tool spindle, the chamfering system being controlled to chamfer using the chamfering tools according to the invention and explained at the outset in a first operating mode, and using at least one fly cutter in a second operating mode. This increases the flexibility achieved during chamfering, as the advantages of the fly cutters and the advantages of the chamfering tools according to the invention, respectively, can be used as required. For example, if very large batches of workpieces are used which are to be chamfered using the chamfering tools according to the invention, but the machining of which is interrupted by another batch of workpieces for which the chamfering tools are not designed, this other batch of workpieces could still be chamfered using fly cutters without time-consuming tool changes. In this context, the tool spindle also has a length that is sufficient for clamping a total of at least three or even at least four chamfering tools and for this purpose has an effective clamping length of preferably at least 100 mm, in particular at least 300 mm. Depending on the effective clamping length of the workpiece spindle, the tool spindle can also be mounted on both sides.

A particularly preferred embodiment of the chamfering system having at least two chamfering tools preferably comprises a mounting unit formed of at least two chamfering tools and having a common axis of rotation for the tools, by means of which mounting unit a relative axial position and/or a relative rotational position with respect to the common axis of rotation is defined between a predetermined reference tooth of each chamfering tool. The advantages of this design are shown in the following explanations.

The tooth flanks therefore are already present on the workpieces on which the chamfers are produced in rolling machining engagement. This means that not only the profiles of the chamfering tool(s) are adapted to the workpiece toothing, but the relative position between the chamfering tool and the workpiece to be chamfered must be brought into the setting designed for the machining engagement. Similar to the centering process in toothing grinding, it must therefore be ensured that the positions of the tool teeth relative to the toothing to be chamfered are known. This usually takes place directly via reference surfaces on the machine, for example the table surface of the workpiece spindle and the planar surface of the cutting spindle, with each spindle passing through a defined zero position per revolution.

The relative position of the toothing to be chamfered with respect to the machine results from the clamping height above the table surface and positions of the tooth gaps of the toothing to be chamfered relative to the table spindle can be detected, in a manner familiar to a person skilled in the art, using calibrated measuring systems such as centering sensors.

Due to the embodiments of the chamfering tool via the helical shape with regular pitch at the periphery (clamping grooves), the positions of the tool teeth of a chamfering tool are known to be one below the other. It is therefore sufficient to determine the relative position of a reference tooth of the chamfering tool with respect to the machine, which position results, for example, from its spacing from the planar surface of the cutting spindle and its position relative to the rotational position of the cutting spindle. In this way, the relation between the positions of the chamfering tool teeth relative to the toothing to be chamfered can be established via the machine base. The movements required for reaching the correct position can be set/achieved by the machine control via the machine axes controlled thereby.

Despite the use of two chamfering tools and the greater effort for determining the position that is to be expected thereby, i.e. determining once per tool, the preferably provided mounting unit results in a significant reduction in the effort required for the setter, since the predefined definition of the tooth position of a chamfering tool in relation to another chamfering tool means that the position only has to be established once via the mounting unit, for example using the method explained above. From the defined predefinition, this can then be automatically determined for the other chamfering tool purely by calculation and can thus be reached without additional effort via positioning or calibration measures carried out by the operator.

This makes the use of the chamfering system less prone to errors, and because the pre-set mounting unit is provided in advance, there is also no longer any risk of incorrect arrangement of the chamfering tools in the machine.

In a particularly preferred embodiment, the at least two chamfering tools can have a common base body and be rigidly connected to one another via defined reference surfaces. In an even more preferred embodiment, the two or even more chamfering tools can be manufactured from a common base body. A more preferred embodiment consists in a “Quattro” mounting unit with four chamfering tools designed according to the invention.

The one-time predetermined relative position of the chamfering tools with their toothings one below the other can thus be maintained and thus remains intact even after regrinding of the chamfering tools. The common base body or the integral design also allow reliable, optionally even better concentricity properties.

It may also be possible to produce an assignment of the relative position information between the individual chamfering tools of the mounting unit and the mounting unit itself. This could be done, for example, via a data carrier attached to the mounting unit, or, for example, via a storage space region of a central store assigned to the mounting unit and allocated via an identification code of the mounting unit. In this way, tool management of the individual mounting units can be implemented; in addition, process data of individual chamfering tools or such a set of chamfering tools assigned to a mounting unit can also be saved/stored, for example.

In structural terms, a plurality of implementation options are conceivable. This means that a common tool body can already contain all the distances predefined between individual chamfering tools and in front of and behind said tools. As already explained above, it is entirely conceivable for a common tool body to contain a plurality of tools having different chamfering technology. Furthermore, it is not absolutely necessary that the cutting directions of individual chamfering tools on the common tool body are in the same direction, as the direction of rotation about the common axis of rotation can also be changed between the use of different chamfering tools. Form-fitting connections to the tool spindle are preferably provided. If a plurality of tool base bodies are to be used, which for example each carry two chamfering tools, a form-fitting connection between the two tool base bodies can be provided. In principle, it is possible to select a specific cutting material; for example, cutting edges made of different cutting materials can be used. In a preferred embodiment, the service life of all tools is maintained at as uniform a level as possible and, if necessary, this is influenced by a coating that increases the wear resistance of the tools. The common tool body can have a central axial bore with which it can be held on cutter arbors. A more alternative design would be a solid design as a shaft tool. The common tool body in the tool head of the machine used can be supported on one side (floating); an alternative would be support on both sides, which is particularly suitable for embodiments with four chamfering tools.

In addition, the invention also protects a gear-cutting machine having a main machining station for producing a workpiece toothing by machining, which machine has a chamfering station which is equipped with at least one chamfering tool according to one of the aspects mentioned at the outset or a chamfering system according to one of the further mentioned aspects. The main machining station could be, for example, a hobbing station or a power skiving station; shaping stations are also conceivable. It may be the case that the main machining station and the chamfering station share the same workpiece table/workpiece spindle, such that parallel machining operations are possible. However, variants are also conceivable and preferred in which a workpiece changing system moves the produced toothings from the workpiece spindle of the main machining station to a separate workpiece spindle of the chamfering station. Multi-spindle solutions, in particular two-spindle solutions, are also conceivable, in which the workpiece spindles are arranged on a rotary carrier and can be moved between the machining station and the chamfering station by rotation of the rotary carrier. The invention can also be used for pick-up systems, in which one or more workpiece spindles are provided as spindles.

In terms of methods, the invention relates to a method for producing a chamfer on the tooth edges of a tooth flank side of a workpiece toothing using a chamfering tool according to the invention by carrying out a single-flank machining process. In this case, chamfering takes place in rolling connection.

In the method, the tooth edges on both tooth flank sides of an end face of the workpiece toothing are also chamfered using a chamfering system according to the invention, by carrying out two single-flank machining processes. It is also possible to produce chamfers on both end faces by further single-flank machining operations on the other end face.

In a particularly preferred method embodiment, a chamfering tool of which the axial length is greater than the axial length required for cutting the relevant chamfer flank is used to chamfer a workpiece toothing using a first tool region as viewed with respect to the axial length of the chamfering tool, and to chamfer another workpiece toothing of the same type using a second tool region that has at least partially different tool teeth. As already explained above, this increases the service life of the chamfering tools of the chamfering system.

In a particularly preferred embodiment, which can be used when chamfering helical workpiece toothings, the chamfering takes place on the respective edges (the blunt and pointed edges) of the helical toothing in different pivot positions of the tool axis of rotation; the pointed side, in relation to the orthogonal position viewed in the axial spacing direction, is machined preferably at a pivot angle of less than 10°, in particular less than 5° and/or the blunt side is machined at a pivot angle of preferably more than 5°, in particular more than 10° and preferably less than 35°, in particular less than 30°. These settings help to produce a chamfer that is as uniform as possible with respect to the desired chamfer parameters. The hobbing offset angle HOA is preferably greater than 10°, in particular greater than 20° and/or preferably smaller than 70°, in particular smaller than 60°.

Furthermore, it is preferably the case that when chamfering the blunt side, work is carried out further off-center, as viewed tangentially, than when chamfering the pointed side, in particular by at least 5 mm, preferably at least 10 mm. This allows favorable use of the remaining degrees of freedom in the design of the tools, such as the pitch angle of the flight pitch(es) or, as viewed axially, the stretching or compression of the tooth profile.

Further details, features and advantages of the invention can be found in the following description with reference to the accompanying drawings, in which

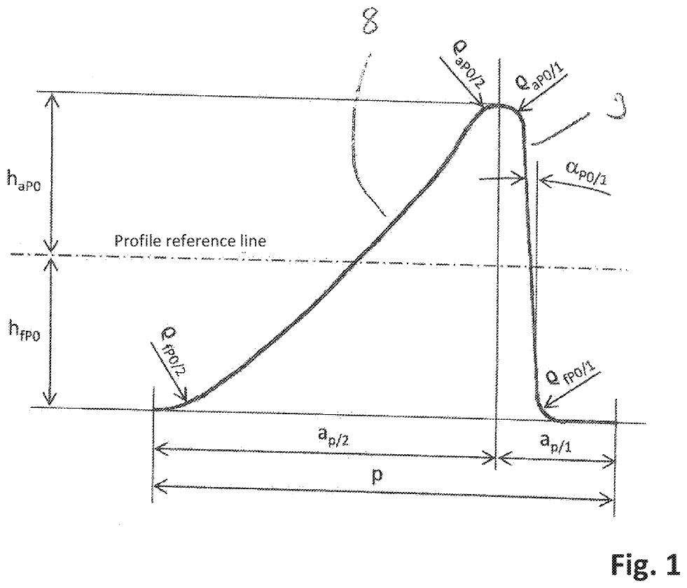

FIG. 1 is an axial section of a tool tooth profile

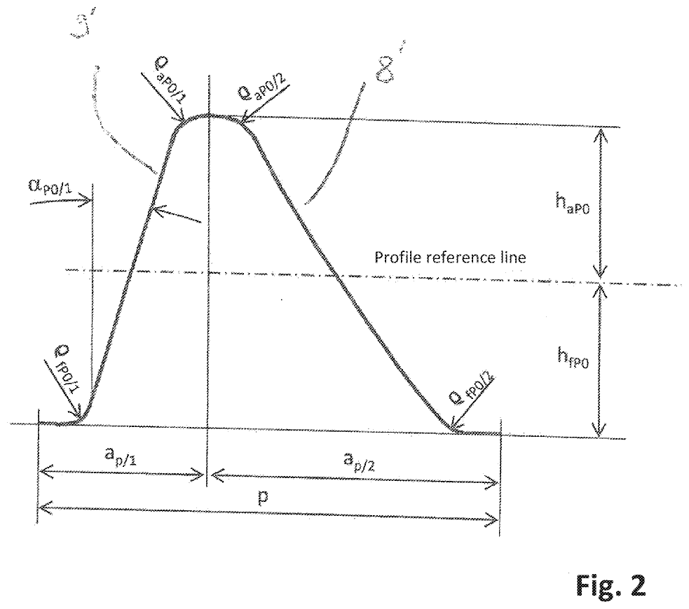

FIG. 2 is an axial section of a tool tooth profile

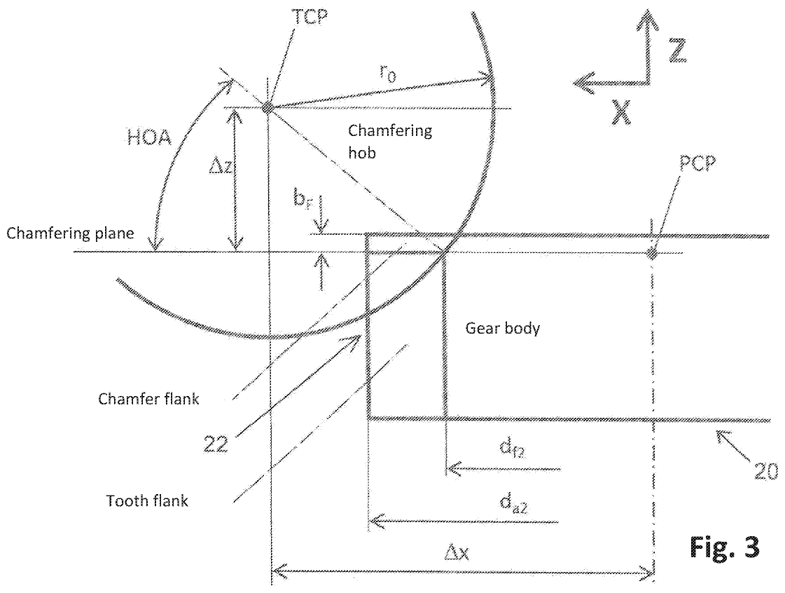

FIG. 3 is a schematic axial section of a chamfering hob in engagement with a gear

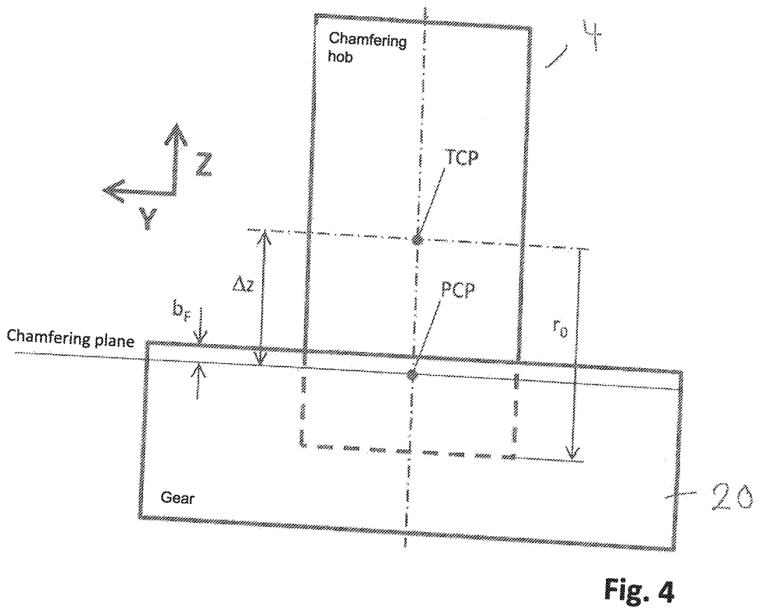

FIG. 4 shows a position of a chamfering hob when cutting the pointed chamfer flank of a helical gear

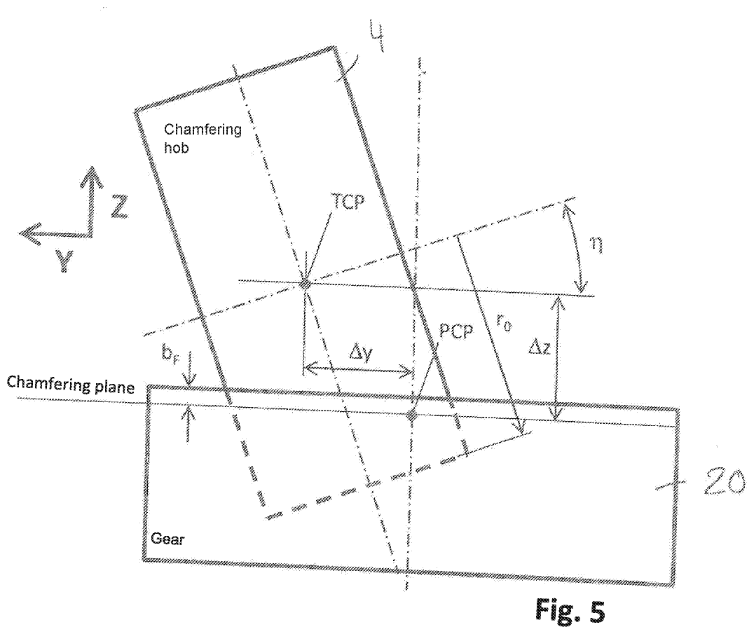

FIG. 5 shows a position of a chamfering hob when cutting the blunt chamfer flank of a helical gear

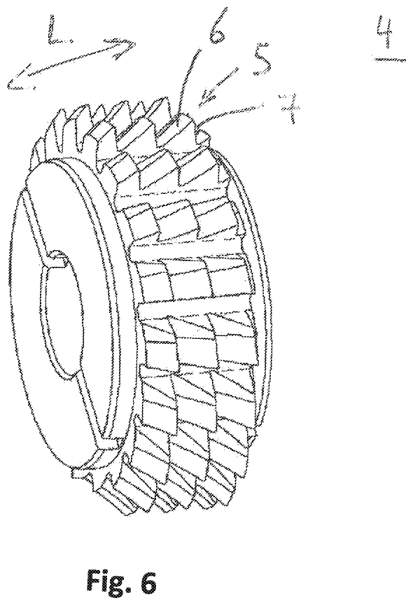

FIG. 6 shows a chamfering hob with an asymmetrical tooth profile

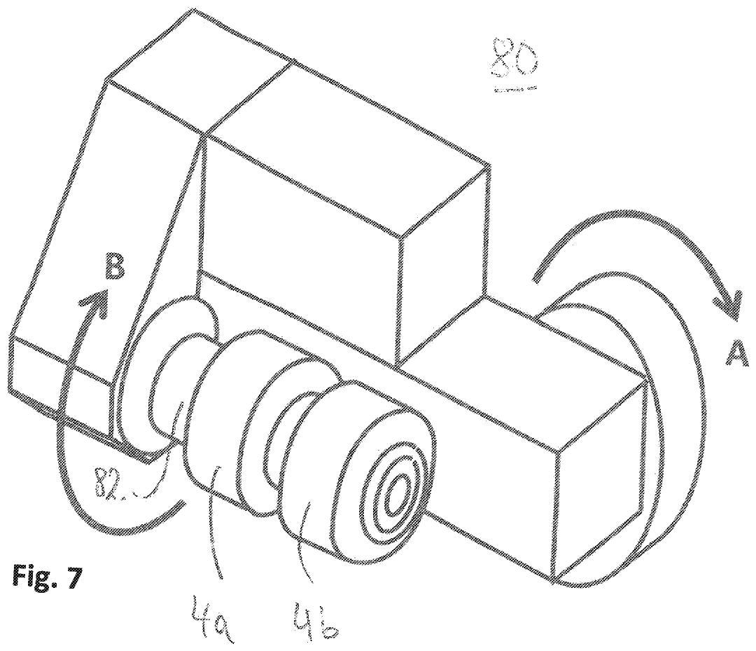

FIG. 7 shows a machining head with two chamfering hobs

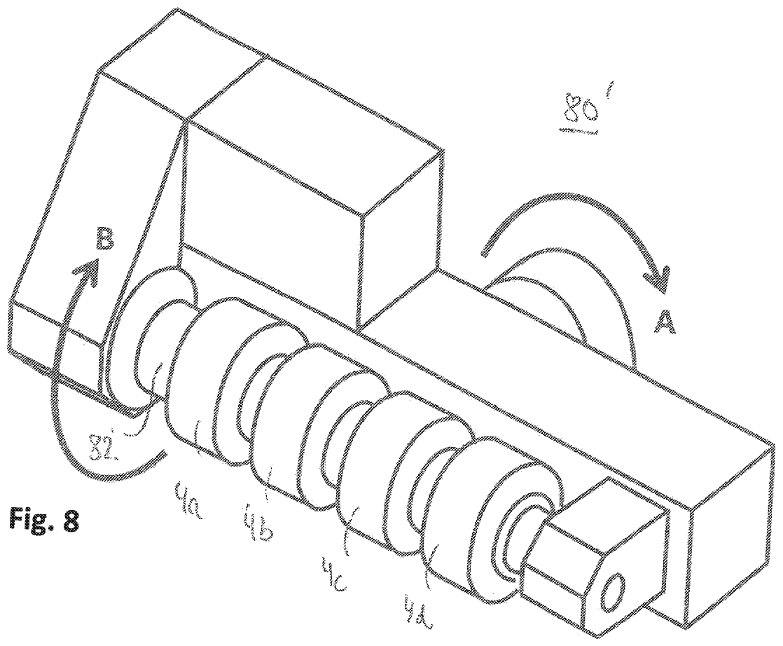

FIG. 8 shows a machining head with four chamfering hobs

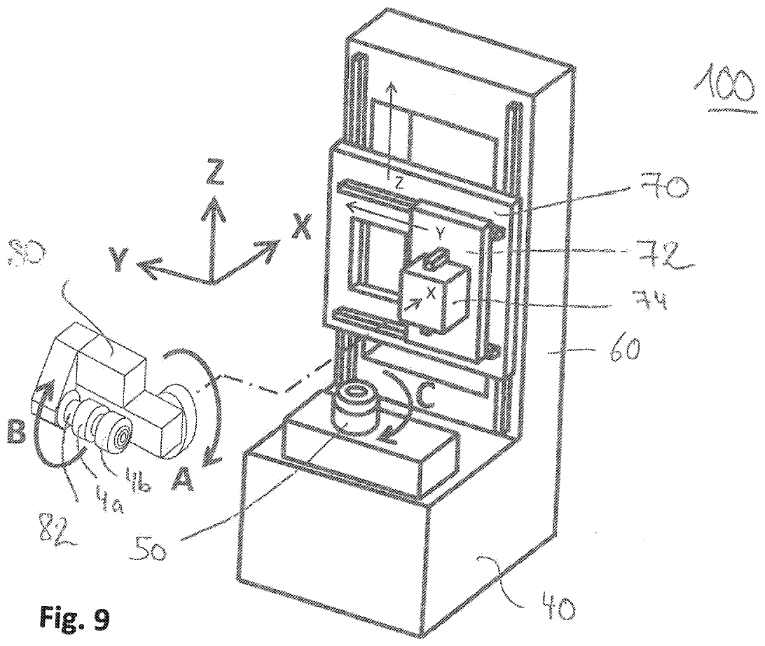

FIG. 9 shows an axial arrangement of a chamfering unit

FIG. 10 shows a fly cutter, and

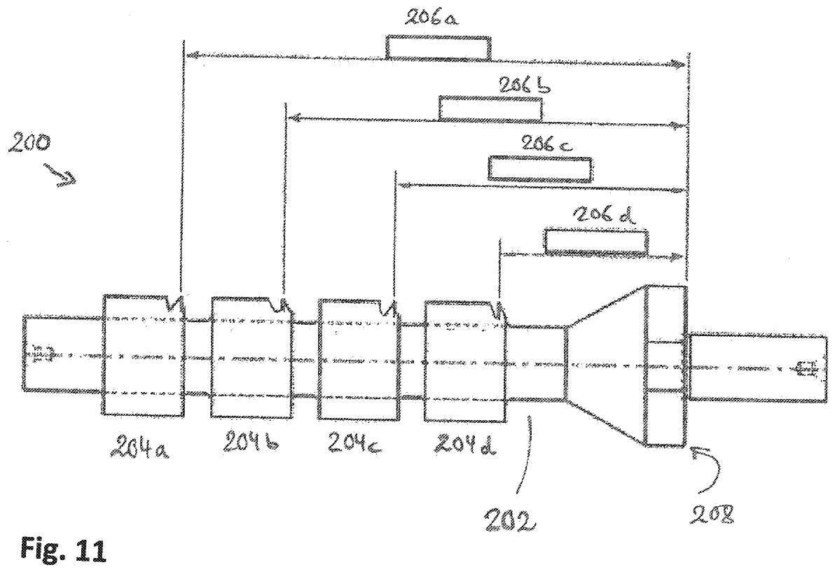

FIG. 11 is an explanatory sketch of a mounting unit with four chamfering tools.

In the drawings, the following symbols are used:

A pivot axis A
B tool spindle axis B
C tool axis C
X radial axis X
Y tangential axis Y
Z axial axis Z
HOA hobbing offset angle
TCP tool center point
PCP part center point
b_{f} chamfer width
dₐ₂ gear tip circle diameter
d_{f2} gear root circle diameter
r₀ tool tip circle radius
η pivot angle
Δx radial distance between TCP and PCP
Δy tangential distance between TCP and PCP
Δz axial distance between TCP and PCP [symbol]
_{fP0/1} tool profile tip radius of the non-cutting tooth flank [symbol]
_{fP0/1} tool profile root radius of the non-cutting tooth flank [symbol]
_{aP0/2} tool profile tip radius of the cutting tooth flank [symbol]
_{aP0/2} tool profile root radius of the cutting tooth flank
α_{P0/1} tool profile angle of the non-cutting tooth flank
p axial pitch of the tool reference profile
a_{p/1} part of the axial pitch of the tool reference profile of the non-cutting tooth flank
a_{p/2} part of the axial pitch of the tool reference profile of the cutting tooth flank
h_{aP0} tip height of the tool reference profile
h_{fP0} root height of the tool reference profile
L tool length

First, with reference to FIG. 9, a chamfering unit 100 is shown together with associated movement axes, which is a possible and preferred embodiment. A workpiece spindle 50 that is rotatably mounted on a machine bed 40 of the chamfering unit 100 for receiving a workpiece (not shown) can be seen on the workpiece side, the axis of rotation of the workpiece spindle (workpiece axis) being denoted by C.

A column 60 is provided on the tool side, which column carries a slide arrangement for implementing linear relative movements between the tool and the workpiece, in this embodiment in the form of mutually perpendicular movement axes X, Y, Z. An axial slide 70 is thus provided, the direction of movement Z of which extends in parallel with the workpiece axis of rotation and therefore vertically in this embodiment. The slide 70 in turn carries a tangential slide 72 with the movement of direction Y. A radial slide 74 is guided in an opening of the tangential slide 72. The radial slide 74 carries a tool head 80 in a pivotable manner (with pivot axis A). In this embodiment, the tool head 80 has an indirectly (CNC) driven tool spindle 82, with spindle axis B. In addition to such indirect drives with a belt drive between the motor and the spindle, a directly CNC driven spindle is also conceivable. In the embodiment shown in FIG. 9, the workpiece spindle 82 carries two chamfering tools, which are explained in more detail below with reference to further drawings.

Due to the arrangement of the radial slide X, the movement of which changes the axial spacing between the tool axis of rotation B and the workpiece axis C, as only the pivot device with pivot axis A, but none of the other linear movement axis slides, the machine axis is exposed only to low loads and moments for the pivot movement and radial movement.

The tool head 80 is shown enlarged again in FIG. 7. One-sided attachment of the tool spindle 82 can be seen. However, in another embodiment, shown in FIG. 8, a tool spindle 82 could also be mounted on both sides and optionally also carry a higher number of tools, for example four chamfering tools 4a, 4b, 4c, 4d.

All these chamfering tools 4a, 4b, 4c and 4d could be chamfering hobs according to the invention, but it is also conceivable that, for example, two of the tools are chamfering hobs according to the invention, while two others are fly cutters as shown in FIG. 10.

In the first case, an asymmetrical chamfering hob could be provided for chamfering the left and right flanks on the upper and lower end faces of a workpiece. In this case, a pivotability of +/−80° or less from the horizontal for the pivot axis A may be sufficient for chamfering purposes. However, it is preferable for a pivotability of more than 160°, in particular more than 180°, to be provided, such that for the design of the tool head 80 of FIG. 7, for example, the two chamfering tools 4a, 4b, which are provided for the blunt and pointed edges in the case of a helically toothed workpiece, for example, work on one end face and, if required, on the other end face after appropriate pivoting.

Each of the chamfering tools 4a, 4b, 4c, 4d may be a tool, as shown in FIG. 6, having helical teeth 5. FIG. 6 shows a single-flight chamfering hob 4, although multiple-flight variants are conceivable. In general, it is preferable for fewer than 8, in particular fewer than 6, flights to be provided.

The tooth profile that is asymmetrical in the axial section of the tool 4 is clearly visible. The teeth 5 are thus provided with a significantly asymmetrical profile, and have a machining tooth flank 6 and a non-machining tooth flank 7. The chamfering hob 4 is therefore intended for only single-flank machining. In FIG. 7, the second chamfering hob on the workpiece spindle 82 would therefore be designed for machining the other flank of the workpiece.

The asymmetrical tooth profile of the chamfering hob 4 for an embodiment is shown in more detail in FIG. 1. The profile 8 of the machining tooth flank 6 is shown in FIG. 1 in part a_{p/2} of the axial pitch of the tool. Starting from the curve in the root region, the profile 8 extends in a concave manner until it passes an inflection point near the transition of the axial pitch of the non-cutting tooth flank a_{p/1} before transition into the tooth tip rounding. It is clear that the profile curve 9 in the region of the non-cutting tooth flank 7 between the tip rounding and the root rounding extends significantly more steeply than the profile 8 on the cutting tooth flank 6.

For this embodiment, the tool profile of the chamfering tool which machines the pointed edge of the workpiece (for example, helically toothed with helix angle β between 10° and 35°) is shown in FIG. 2. Here, too, a clear asymmetry can be seen; the profile curve 8′ on the cutting tooth flank extends significantly less steeply than the profile curve 9′ on the non-cutting tooth flank of the tool. However, the difference is less pronounced than in the profile curve 8, 9 shown in FIG. 1 for machining the blunt edge of the workpiece.

The asymmetry of the tooth profiles can be represented as quotients of the ratios (a_{p/2}:a_{p/1}) for the blunt and pointed sides, respectively. It is preferable for the quotient of the ratio (a_{p/2}:a_{p/1})_{blunt} in the case of the tool profile chamfering the blunt edge and the ratio (a_{p/2}:a_{p/1})_{pointed} in the case of the tool profile chamfering the pointed edge is greater than 1.1, preferably greater than 1.25, in particular greater than 1.4 and/or less than 3.0, preferably less than 2.5, in particular less than 2.0.

The relative position of the machining operation is shown schematically in FIG. 3, the drawing plane of FIG. 3 being the radial-axial plane and the viewing direction thus the tangential direction Y for the coordinate system shown in FIG. 9.

The machine axis settings for chamfering are selected so that the chamfering hob meets the tooth root of the workpiece 20 at its tip circle at the deepest radial advancement (ΔX minimum) with a set hobbing offset angle HOA at a spacing of the chamfer width b_{F} from the end face of the workpiece facing the tool. The axial axis Z and the radial axis X are preferably the advancement and feed axes. In a preferred design, the Z-axis position of the tool center TCP is set to the height shown in FIG. 3 (at a distance ΔZ from the chamfering plane) and the relative movement between the tool 4 and the workpiece 20 can be limited to a purely radial movement X. However, combined XZ movements are also conceivable.

FIG. 4 shows a preferred relative position between the tool 4 and the workpiece (gear) 20 in the tangential/axial plane; here, the viewing direction is the radial direction X. In FIG. 4 it can be seen that the pivot angle A is set to zero, as a specific embodiment, as explained above, for chamfering the pointed tooth edge of the workpiece at a small pivot angle η.

For chamfering the blunt tooth edge of the workpiece 20, on the other hand, a pivot angle n that is clearly different from zero is preferred as the setting for the pivot axis A. In addition, as can be clearly seen from a comparison of FIGS. 4 and 5, the tool 4 is arranged off-center; the planes containing the tool center TCP or the workpiece center PCP orthogonally to the tangential direction Y are spaced apart by ΔY.

In contrast to the fly cutter shown in FIG. 10, the chamfering hob 4 shown in FIG. 6 has a significantly larger region of cutting edges, due to the plurality of teeth for each flight. Even if not all tooth edges have a machining effect in one machining position, the machining region can be moved along the axial axis by axial displacement with respect to the tool axis and thus new, still-unused cutting edges can always be used for machining before the chamfering tool has to be reconditioned or replaced. This also results in advantages in the tool service life.

The chamfering hob shown in FIG. 6 and also the tool profiles shown in FIGS. 1 and 2 are matched to the workpiece to be chamfered at the intended machining relative positions and are therefore workpiece-specific. The fly cutter 14 shown in FIG. 10, on the other hand, with its symmetrical design of the cutting edges formed by indexable inserts 15, can be used independently of the workpiece; when it is used, the chamfer is formed on the workpiece by means of coupled machine axis movements, which are carried out individually depending on the workpiece to be chamfered.

In an embodiment of the tool head 80′ shown in FIG. 8, a design with extremely flexible application possibilities is created by combining two chamfer hobs and two fly cutters. For example, a larger batch of identical workpieces, for which the chamfering hobs are designed, can be machined, but in the meantime workpieces not matching this batch of workpieces can also be chamfered by using the fly cutters.

In FIG. 11, the chamfering system explained above is briefly explained again in terms of the mounting unit. A mounting unit 200 having a common base body 202 that carries four chamfering hobs 204a, 204b, 204c and 204d is shown schematically. The spacings between the individual chamfering tools are defined and no longer change when using the mounting unit 200. The rectangular boxes with reference numbers 206a, 206b, 206c and 206d schematically indicate the defined spacing between a planar surface of the milling spindle 208 and the axial position of the first full tooth of each chamfering tool; the rotational position of this tooth is aligned in the same way in this embodiment. Both these axial positions and the rotational positions are stored and are available to an operator of a chamfering machine when using the mounting unit 200 in order to be able to make the position settings for chamfering each individual chamfering tool of the mounting unit 200 as explained above.

The invention is not limited to the features and details described in the embodiments provided above. Rather, the features of the following claims and the above description may be essential, individually and in combination, for implementing the invention in its different embodiments.

1. Chamfering tool (4) for chamfering workpiece toothings (22), comprising a helical toothing having, for each flight, a plurality of teeth (5) with a geometrically defined cutting edge and having a tooth profile (8, 9; 8′, 9′) which is designed for single-flank machining in rolling machining engagement with the workpiece toothing (22) and is asymmetrical as viewed in the axial section of the tool.

2. Chamfering tool according to claim 1, wherein the ratio of the axial length (a_{p/1}) of the non-machining tooth flank side of the tooth profile to the axial length (a_{p/2}) of the machining side is smaller than 1, and/or is greater than 0.05.

3. Chamfering tool according to either claim 1, wherein a predominant part of the tooth profile is concave on the machining tooth flank side and transitions into a convex shape toward the tooth tip.

4. Chamfering tool according to claim 3, wherein the angle of pressure of the tooth profile on the machining tooth flank side between the tooth root and transition decreases into the convex region, with a relative change factor of greater than 0.1 and/or smaller than 10.

5. Chamfering tool according to claim 1, the axial length (L) of which extends beyond a contact length of the machining operation having at least two tool teeth, such that in the event of a respositioning of the relative position of the tool and workpiece that matches a displacement of the tool along its axis, other tool teeth can come into machining engagement with the tool at least in part.

6. Chamfering tool according to claim 5, wherein the axial length (L) of the chamfering tool extends at least 50% beyond the contact length.

7. Chamfering system (100) consisting of two or more chamfering tools according to claim 1 wherein a first chamfering tool (4a) is designed for single-flank chamfering of the tooth edges on the left flanks of the tool toothing and a second, in particular differently formed chamfering tool (4b) is designed for single-flank chamfering of the tooth edges on the right flanks of the workpiece toothing.

8. Chamfering system according to claim 7, in which a tool head (80; 80′) carrying one or more chamfering tools (4a, 4b; 4c, 4d) and designed for driving same in rotation can be moved with respect to the workpiece axis of rotation (C) in at least one linearly independent spatial axes (X, Y, Z) and can be pivoted for an angle of inclination (η) of the tool axis with respect to the workpiece axis, wherein a pivot device causing this pivotability (A) is directly carried by a slide setting the axial spacing between the axes, and this slide is carried by a slide arrangement (70, 72) causing the remaining spatial axis movements.

9. Chamfering system according to claim 8, wherein the pivot device allows pivoting by +/−160°.

10. Chamfering system according to claim 7 in which one or more fly cutters (14) are provided as a further chamfering tool, which fly cutters are also still arranged in the same tool head (80′), and wherein the chamfering system is controlled to chamfer in a first operating mode and using at least one fly cutter chamfering tool in a second operating mode.

11. Gear-cutting machine comprising a main machining station for producing a workpiece toothing by machining, and comprising a chamfering system (100) equipped with a chamfering tool according to claim 1.

12. Method for producing a chamfer on the tooth edges of a tooth flank side of a workpiece toothing using a chamfering tool according to claim 1 by carrying out a single-flank machining process.

13. Method for producing a chamfer on the tooth edges on both tooth flank sides of an end face of the workpiece toothing wherein the tooth edges are chamfered using a chamfering system (100) according to claim 7 by carrying out two single-flank machining processes.

14. Method according to claim 12 wherein a workpiece toothing is chamfered by a first tool region as viewed with respect to the axial length (L) of the chamfering tool, and another workpiece toothing of the same type is chamfered by a second tool region having at least partially different tool teeth.

15. Method according to claim 12 in which the workpiece toothings are helically toothed, and the chamfering tools for chamfering the pointed edge and the blunt edge of the helical toothing take place in different pivot positions of the tool axis of rotation with respect to the workpiece axis of rotation, wherein, in relation to the orthogonal position of the axes of rotation (B, C) as viewed in the direction of the axial spacing, the pointed side is machined at a pivot angle (n) of less than 10° and/or the blunt side is machined at a pivot angle (η) of preferably more than 5° and less than 35°.

16. Method according to claim 15 wherein when chamfering the blunt side, work is carried out further off-center, as viewed tangentially, than when chamfering the pointed side by at least 5 mm.

17. Chamfering system according to claim 7 comprising a mounting unit that is formed of at least two of the chamfering tools and has a common axis of rotation for the tools, by means of which mounting unit a relative axial position and/or a relative rotational position with respect to the common axis of rotation is defined between a predetermined reference tooth of the chamfering tools.

18. Gear-cutting machine comprising a main machining station for producing a workpiece toothing by machining, and comprising a chamfering system (100) according to claim 7.

19. Method according to claim 13 wherein a workpiece toothing is chamfered by a first tool region as viewed with respect to the axial length (L) of the chamfering tool, and another workpiece toothing of the same type is chamfered by a second tool region having at least partially different tool teeth.

20. Method according to claim 13 in which the workpiece toothings are helically toothed, and the chamfering tools for chamfering the pointed edge and the blunt edge of the helical toothing take place in different pivot positions of the tool axis of rotation with respect to the workpiece axis of rotation, wherein, in relation to the orthogonal position of the axes of rotation (B, C) as viewed in the direction of the axial spacing, the pointed side is machined at a pivot angle (η) of less than 10° and/or the blunt side is machined at a pivot angle (η) of preferably more than 5° and less than 35°.
